(19) United States
(12) Patent Application Publication
(10) Pub. No.: US 2008/0187195 A1
(43) Pub. Date: Aug. 7, 2008

(54) Image Processing System, Particularly for Circular and Helical Cone-Beam Ct

(75) Inventors: Thomas Kohler, Norderstedt (DE); Roland Proksa, Hamburg (DE); Andy Ziegler, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 11/911,214

(22) PCT Filed: Apr. 10, 2006
(86) PCT No.: PCT/IB06/51086

§ 371 Date: Oct. 11, 2007

(30) Foreign Application Priority Data
Apr. 14, 2005 (EP) 05102970.0

(51) Int. Cl. G06K 9/00

(52) U.S. Cl. 382/128

(57) ABSTRACT

The invention relates to an examination apparatus with an X-ray device (10) for circular or helical cone-beam CT acquisition of projections images (Pᵢ(E₁), Pᵢ(E₂)) of a patient (1) with different energy spectra (E₁, E₂) and/or with an energy-resolved detection. By a combination of the projections, images (I_{bone,i,} I_{tissue,i}) can be calculated that show predominantly the bone structure and the soft tissue, respectively. Therefore, a 3D model (M_{bone}) of the bone structure and a 3D model (Mₜᵢₛₛᵤₑ) of the tissue can be reconstructed separately. After removal of artifacts from the bone-structure model (M_{bone}), both separate 3D models can be integrated to a combined model (M) of the body volume with a high image quality.

The invention relates to a method and an image processing system for the generation of a three-dimensional (3D) model of a body volume from X-ray projections, an examination apparatus comprising said image processing system, and a record carrier with a computer program for the execution of said method.

In the development of modern X-ray CT (computed tomography) devices for medical applications, there is a trend to increase the cone angle of the X-ray source and to use multi-row detectors with a large sensitive area. As the cone angle grows, the volume that can the covered by a single rotation of the X-ray source increases accordingly. Therefore a circular (helical, and so on . . . ) acquisition of the three-dimensional region of interest becomes possible for more and more medical applications. However, known reconstruction algorithms for circular CT produce more artifacts as the cone angle increases. This is mainly caused by an incomplete sampling of variations of the attenuation in z-direction.

Based on this situation it was an object of the present invention to provide means for the generation of a three-dimensional model of a body volume with improved quality, particularly if the underlying images are generated by circular or helical acquisition.

This object is achieved by an image processing system according to claim 1, by an examination apparatus according to claim 8, by a method according to claim 12, and by a record carrier according to claim 19. Preferred embodiments are disclosed in the dependent claims.

According to its first aspect, the invention comprises an image processing system for the generation of a three-dimensional (3D) model of a body volume from X-ray projections, wherein the term “three-dimensional model” shall comprise also the borderline case of a thin slice through the body. The image processing system may particularly be realized by a computer system with usual components like central processing unit, memory, I/O interfaces and the like together with appropriate software. The image processing system comprises the following functional modules or units, which may be realized by (dedicated) hardware, software and/or data:

a) A reconstruction unit for the reconstruction of a first 3D model of the body volume and for the reconstruction of a second 3D model of the body volume, wherein said reconstructions are based on differently oriented X-ray projections. The X-ray projections may particularly originate from a circular or helical trajectory of the associated X-ray source around the body volume. Moreover, at least two of the X-ray projections are based on spectrally different samplings of X-rays and contribute with different weights (i.e. weighting factors) to the first and the second 3D model, respectively. As will be explained in more detail below, X-ray projections “based on spectrally different samplings of X-rays” may particularly be generated by applying spectrally different illuminations or by a spectrally differentiating detection. Preferably about one half of the available projections is based on a first and the other half on a second spectral sampling of X-rays, wherein the two groups of projections contribute with different weight to the 3D models. The reconstruction unit may comprise two separate modules for the reconstruction of the first 3D model and the second 3D model, respectively, or the two models may be reconstructed one after the other by the same sub-module of the reconstruction unit. The reconstruction of 3D models of a body volume from differently oriented X-ray projections may be done by any method known to a person skilled in the art, for example by using algorithms of Filtered Backprojection (FBP), Algebraic Reconstruction Technique (ART), Maximum Likelihood (ML), or variants thereof.
b) A combination module for joining the reconstructed first 3D model and the reconstructed second 3D model to a combined 3D model of the body volume. In a typical case the combination of the first and second 3D model can simply be achieved by their superposition.

An image processing system of the kind mentioned above has the advantage to exploit information contained in two 3D models that were generated with projections based on different X-ray spectra. As the attenuation coefficient depends on the X-ray energy in a way that is specific for the material, the grey values of different materials will generally not change proportionally to each other in X-ray projections based on different X-ray spectra. This effect can be used to produce subtraction projections in which the contributions of a certain material cancel while those of others do not, resulting in an enhancement of the other materials. Therefore, the reconstruction can be designed such that different structures of the imaged body volume will appear enhanced in the two 3D models, wherein all available information is finally integrated in the combined 3D model.

According to a preferred embodiment of the invention, the reconstruction unit is adapted to reconstruct the first 3D model and the second 3D model of the body volume with different algorithms which are specifically adapted to the weighted processed projections and to associated aritfacts. As for example cone-beam and splay artifacts are more severe in a bone image than in a tissue image, it is possible to compensate for artifacts which are special or most severe for the reconstructed component.

In a further development of the invention, the image processing system comprises a post-processing module for image enhancement—particularly for the removal of artifacts—of the first 3D model and/or of the second 3D model before they are combined. The post-processing module is preferably adapted to segment bone structures in one of the 3D models of a (human or animal) body volume. The post-processing module can exploit the fact that certain distortions or artifacts in 3D reconstructions depend on the characteristics of said reconstructions, e.g. the enhanced body structure, and that they may therefore be corrected specifically. It is for example possible to generate 3D models which predominantly show bone structures such that artifacts can be removed based on a priori knowledge about said structures.

According to another embodiment of the invention, the combination module is adapted to reconstruct the combined 3D model of the body volume such that a desired contrast is enhanced or reduced.

The image processing unit preferably further comprises a display unit for the graphical display of the X-ray projections, of the first 3D model, of the second 3D model and/or of the combined model. In medical applications, such a display unit allows the physician an easy and intuitive inspection of the available data.

The invention further relates to an examination apparatus which comprises the following components:

An X-ray device for the generation of X-ray projections of a body volume from different directions, wherein projections generated by the device can selectively be based on at least two spectrally different samplings of X-rays.

An image processing system of the kind mentioned above, i.e. with (i) a reconstruction unit for the reconstruction of a first and a second 3D model from differently oriented and spectrally differently sampled X-ray projections generated with the X-ray device, and with (ii) a combination module for the combination of said first and second 3D model.

For more information on details, advantages and further developments of the examination apparatus, reference is made to the description of the image processing system above.

The X-ray device of the examination apparatus may particularly comprise a cone-beam CT system with an X-ray source rotatably mounted on a gantry and an X-ray detector opposite thereof, wherein the angle of the cone-beam typically ranges from 10 to 70.

Said cone-beam CT may particularly be adapted and used for circular or helical acquisitions, i.e. the generation of X-ray projections during a rotation of the X-ray source (and active detector area) around a resting object on a closed circular or on a helical trajectory, respectively. 3D models reconstructed from circular or helical cone-beam CTs usually show many artifacts. These artifacts can be reduced in the examination apparatus by exploiting characteristics of images generated with different X-ray spectra.

There are different possibilities to generate projections that are based on spectrally different samplings of X-rays. According to a first variant, the X-ray device of the examination apparatus is adapted to generate X-radiation of at least two different spectra. The X-ray source of this device may for example be operated with different voltages and/or different spectral filters may be applied at its output.

According to a second variant, the X-ray device (or, more precisely, the X-ray detector thereof) is adapted to measure transmitted X-radiation selectively with at least two different spectral weighting functions. An energy resolved detection system may for example be used for this purpose in combination with a polychromatic X-ray source, wherein the detection system discriminates between at least two different energy ranges, or—more generally—produces signals, which correspond to an energy weighted X-ray flux with two different weighting functions. The detection system may provide the spectrally differently weighted projections simultaneously for each exposure to (polychromatic) X-radiation (comparable to color video images). Alternatively, the detection system may be adapted to produce for each exposure a projection that corresponds to one predetermined spectral weighting, for example by using different X-ray filters in front of the detection system.

The invention further relates to a method for the generation of a 3D model of a body volume from X-ray projections, said method comprising the following steps:

a) The generation of differently oriented X-ray projections of the body volume, wherein at least two projections are based on spectrally different samplings of X-rays (wherein the number of differently oriented X-ray projections for each spectral sampling shall be large enough to allow a three-dimensional reconstruction of the body volume). The X-ray projections may preferably originate from a circular or helical trajectory of the associated X-ray source around the body volume.
b) The reconstruction of a first and a second 3D model of the body volume from the projections of step a), wherein projections based on spectrally different samplings of X-rays contribute with different weights to said 3D models.
c) The combination of the first and the second 3D model to a combined 3D model of the body volume.

The method comprises in general form the steps that can be executed with an examination apparatus of the kind described above. Therefore, reference is made to the preceding description for more information on the details, advantages and improvements of that method.

The first 3D model and the second 3D model of the body volume may preferably be reconstructed with different algorithms which are specifically adapted to the weighted projections and to associated aritfacts.

In a further development of the method, the first and/or the second model is post-processed to enhance image quality, particularly to remove artifacts before it is combined with the other model in the step c).

The first 3D model and the second 3D model of the body volume may preferably be combined such that a desired contrast is enhanced or reduced.

The X-ray projections may particularly be generated with at least two different spectra of illuminating X-rays. A first illuminating X-ray spectrum may for example comprise to more than 90% of its total energy quanta with energies between 80 and 140 keV. Alternatively or additionally, a second illuminating X-ray spectrum may comprise to more than 90% of its total energy quanta with energies between 50 and 90 keV. The weighted difference of X-ray projections generated with such spectra can be designed such that it predominantly shows bone structures or soft tissue of a biological body volume.

In another embodiment of the method, X-rays that are transmitted through the body volume are measured with at least two different spectral weighting functions, i.e. in an energy resolved way. The spectral weighting may be achieved by intrinsic features of the applied detection system and/or by the insertion of filter materials (e.g. A1) in the optical path of the X-rays in front of the detector.

Finally, the invention comprises a record carrier, for example a floppy disk, a hard disk, or a compact disc (CD), on which a computer program for the for the generation of 3D model of a body volume from X-ray projections is stored, wherein said program is adapted to execute a method of the aforementioned kind.

These and other aspects of the invention will be apparent from and elucidated with reference to the embodiment(s) described hereinafter.

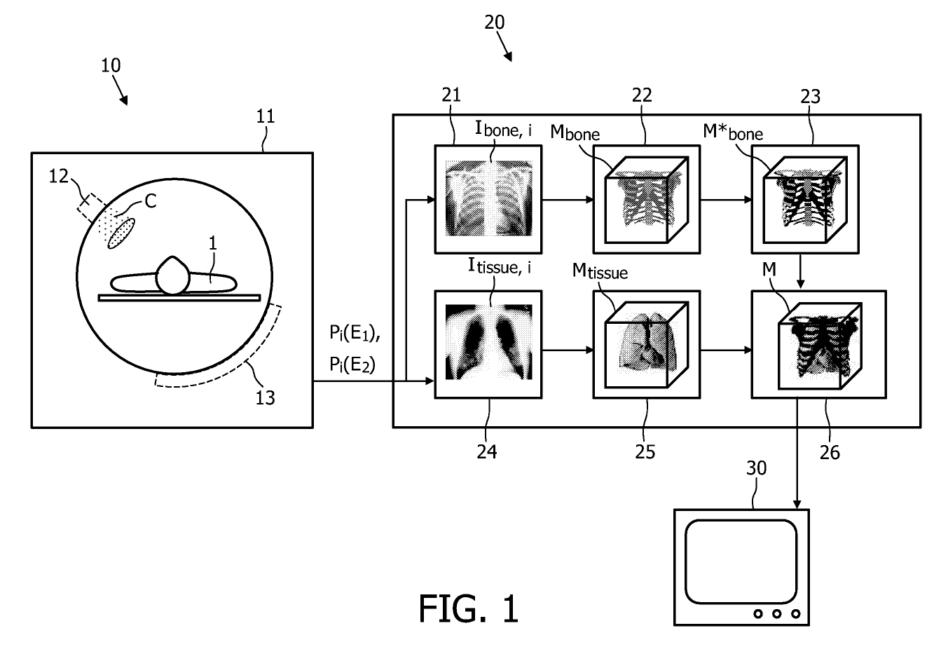

FIG. 1 schematically shows an examination apparatus according to the present invention;

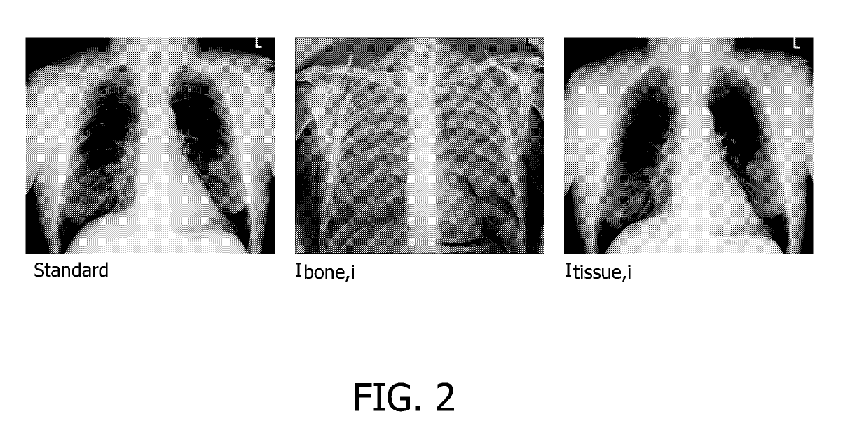

FIG. 2 shows a comparison of a standard radiograph of the thorax (left), a bone-only image (middle), and a soft-tissue-only image (right).

On the left side of FIG. 1, a CT device 10 can be seen with a gantry 11 in which an X-ray source 12 is arranged such that it can be rotated for 360° around a patient 1 lying on a table in the centre of the device. If the tabel is at rest during the rotation, a circular acquisition is produced; if the table is moved in axial direction during the rotation, non-circular (e.g. helcial) acquisitions can be produced. A multi-row detector 13 is always opposite to the X-ray source 12 and records the projection images Pi of the patient 1. The X-ray source 12 and the corresponding detector 13 may particularly be designed such that a relatively large cone-beam C of X-rays is a generated and recorded, the cone angle typically ranging from 1° to 7°.

Moreover, the X-ray source 12 is able to generate X-ray beams with different spectra, for example beams with a first mean energy E₁ and beams with a second mean energy E₂, wherein E₁≠E₂. Additionally or alternatively, the X-ray detector 13 may be adapted for an energy resolved or spectrally weighted detection of transmitted X-rays.

The CT device 10 is bidirectionally coupled to an image processing system or computer 20. FIG. 1 schematically shows the logical modules of said computer 20 which may be realized by a combination of hardware, software and data.

Two input and pre-processing modules 21 and 24 receive projections Pᵢ(E₁), Pᵢ(E₂) (i=1, 2, 3, . . . ) from the CT device 10 that are based on spectrally different samplings of X-rays. Said projections may for example correspond to two different energy windows of a spectrally resolving detector. In the following it is assumed that the projections were generated with a first X-ray spectrum E₁ and a second spectrum E₂ of the X-ray source 12, respectively. The projections Pᵢ(E₁) may for example be generated during a first rotation of the X-ray source 12, while the projections Pᵢ(E₂) are generated during the subsequent rotation. Alternatively, the projections Pᵢ(E₁) and Pᵢ(E₂) may be generated in an alternating sequence during one or more rotations of the X-ray source 12.

In the technique of “dual energy” or “spectral” radiography, projections based on spectrally different samplings of X-rays are added with different weights to suppress certain structures in the images and to enhance others. In the simplified case of monochromatic measurements, the values G₁, G₂ of a pixel in projections generated with a first and a second energy E₁ and E₂, respectively, may for example be given by

G₁=μ_{bone}(E₁)·x_{bone}+μₜᵢₛₛᵤₑ(E₁)xₜᵢₛₛᵤₑ

G₂=μ_{bone}(E₂)·x_{bone}+μₜᵢₛₛᵤₑ(E₂)·xₜᵢₛₛᵤₑ

with μ_{bone}(Eᵢ) being the attenuation coefficient of bones for energy Eᵢ, μₜᵢₛₛᵤₑ (Eᵢ) being the attenuation coefficient of soft tissue for energy Eᵢ, and with x_{bone}, xₜᵢₛₛᵤₑ being the thickness of bone and soft tissue, respectively, in the path of the considered X-ray. By choosing appropriate weighting factors w₁ and w₂, difference images (w₁·G₁-w₂·G₂) can be produced in which the contribution of x_{bone} or xₜᵢₛₛᵤₑ vanishes, resulting in an enhanced representation of the other structure.

In the more general and typical polychromatic case, both spectra (in the case of volt switching) or weighting functions (in the case of spectrally resolved measurements) underlying the projections are broad and overlapping, and a non-linear system results. The values G₁, G₂ of a pixel in two spectrally differently sampled projections can then be described as

G₁=∫dE S₁(E)exp(−∫ds(αₚ(x, y)f_{P}(E)+α_{c}(x, y) f_{c}(E))),

G₂=dE S₂(E)exp(−∫ds(α_{P}(x, y)f_{P}(E)+α_{c}(x, y)f_{c}(E))).

Here, f_{P}(E) and f_{c}(E) are functions describing energy dependant absorption mechanisms, for example that of the photoelectric effect (with f_{P}(E)=E^{3.2}) and that of Compton scattering (with f_{c} being the Klein-Nishina function). a_{P}(x,y) and a_{c}(x,y) are the corresponding absorption coefficients. The functions S₁(E) and S₂(E) describe the spectral weighting that may be achieved on the illumination side and/or the detection side of the imaging process. As the ratio of a_{P} and a_{c} is known for bones, the contribution of bones can be determined (and separated) in the projection data (cf. Alvarez and Macovski: “Energy selective reconstruction in X-ray computerized tomography”, Phys. Med. Biol., pp. 733-744 (1976), which is incorporated into the present application by reference).

According to the principles explained above, module 21 calculates projection images I_{bone,i} in which bone structures are enhanced and soft tissue is suppressed, e.g. by subtracting with appropriate factors w₁, w₂ two projections having the same geometry but different spectrum, i.e. I_{bone,i}=w₁·Pᵢ(E₁)—w₂·Pᵢ(E₂). Similarly, module 24 generates projection images I_{tissue,i} in which bone structures are suppressed and soft tissue is enhanced.

A further module 22 then reconstructs a first three-dimensional model M_{bone} of the imaged body region from the differently oriented bone-images I_{bone,i} calculated in module 21. Said reconstruction may be achieved by algorithms known in the art, for example FBP, ART, ML, or variants thereof. In a similar way, a module 25 reconstructs a second three-dimensional model Mₜᵢₛₛᵤₑ from the calculated tissue-images I_{tissue,i} of module 24. It should be noted that a “three-dimensional model” shall in this context also comprise reconstructed slices or cross-sections through the body volume, which extend in a dimension perpendicular to the original projections.

The algorithms used in the aforementioned modules 22, 25 may be specifically adapted to the processed projections and associated aritfacts. Thus the algorithm that reconstructs the first 3D model M_{bone} in module 22 may particularly be designed to compensate for cone-beam and splay artifacts. Methods to achieve such a compensation are for example described in J. D. Pack, F. Noo, and R. Clackdoyle. “Cone-beam reconstruction using the backprojection of locally filtered projections”, IEEE Trans. Med. Imag., 24(1):70-85, 2005, which is incorporated into the present application by reference.

The algorithms used in the modules 22, 25 may further be adapted to enhance or reduce a desired contrast. Since the separated sets of projections I_{bone,i}, I_{tissue,i} can be used to create a linear combination of them, this linear combination can be optimized in such a perspective, that a desired contrast is enhanced, or removed. For example if bone contrast (i.e. the difference in grey values between a region with bone and a region without bone in the bone image) is not desired, a small fraction of the bone projections I_{bone,i} can be added linearly to the soft-tissue projections I_{tissue,i} in such a way, that the soft-tissue projections have the lowest entropy. As will be explained below, a similar contrast enhancement can equivalently be achieved in module 26 by a linerar combination of 3D models.

For circular and helical cone-beam CTs it is known that reconstructed 3D models comprise artifacts that are mainly due to sharp edges from bone-tissue borders. Since said edges are present in the first calculated images I_{bone,i}, the 3D model M_{bone} will contain such artifacts, too. As this model contains only bone structures, it is however possible to post-process it for a removal of the artifacts. Said post-processing is done by another module 23, resulting in an artifact-free model M*_{bone}. The post-processing may for example be done by segmentation of bones in the primary 3D model M_{bone}, particularly by thresholding.

The 3D tissue model Mₜᵢₛₛᵤₑ, on the contrary, is free of the aforementioned artifacts. This model therefore needs no further processing to improve image quality.

In a final module 26, the 3D tissue-model Mₜᵢₛₛᵤₑ and the post-processed 3D bone-model M*_{bone} are integrated into a combined model M. As the two model components M*_{bone} and Mₜᵢₛₛᵤₑ are generated with the same geometry and as it may be assumed that the patient 1 has not moved during the generation of all projections Pᵢ(E₁), Pᵢ(E₂), the combination of the two models M*_{bone} and Mₜᵢₛₛᵤₑ can be achieved by a simple pixelwise superposition. Optionally this superposition may be done with different weighting factors and/or with different colors of the two models. Thus the algorithms used in module 26 may be adapted to enhance or reduce a desired contrast by combining the 3D models M*_{bone} and Mₜᵢₛₛᵤₑ of modules 23, 25 in a linear combination such that a desired contrast is enhanced, or removed.

A monitor 30 connected to the computer 20 allows to display the combined model M and/or any of the intermediate results M_{bone}, M*_{bone}, Mₜᵢₛₛᵤₑ, I_{bone,i}, I_{tissue,i}, Pᵢ(E₁), or Pᵢ(E₂).

In an alternative realization of the image processing system, separate 3D models M(E₁), M(E₂) may first be reconstructed only from projections corresponding to a first spectrum E₁ and a second spectrum E₂, respectively. Said models may then be subtracted with appropriate weights to achieve a 3D bone-model M_{bone} and a 3D tissue-model Mₜᵢₛₛᵤₑ which may be further processed as described above.

FIG. 2 shows from left to right: a standard radiograph of the thorax; a calculated bone-only image I_{bone,i}; and a soft tissue-only image I_{tissue,i}. The latter two images can be used to reconstruct a 3D bone-model M_{bone} and tissue-model Mₜᵢₛₛᵤₑ, respectively.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. Image processing system for the generation of a 3D model of a body volume from X-ray projections, comprising:
a) a reconstruction unit for the reconstruction of a first 3D model and a second 3D model of the body volume from differently oriented X-ray projections, wherein at least two of said projections are based on spectrally different samplings of X-rays and wherein said at least two projections contribute with different weights to the first and the second 3D model, respectively;
b) a combination module for the combination of the first and the second 3D model into a combined 3D model of the body volume.

2. The image processing system according to claim 1, wherein the reconstruction unit is adapted to reconstruct the first 3D model and the second 3D model of the body volume with different algorithms which are specifically adapted to the weighted projections and to associated aritfacts.

3. The image processing system according to claim 1, wherein it comprises a post-processing module for image enhancement of the first 3D model and/or of the second 3D model.

4. The image processing system according to claim 3, wherein the post-processing module is adapted to segment bone structures in the first 3D model.

5. The image processing system according to claim 1, wherein the combination module is adapted to reconstruct the combined 3D model of the body volume such that a desired contrast is enhanced or reduced.

6. The image processing system according to claim 1, wherein it comprises a display unit for the display of the X-ray projections, the first 3D model, the second 3D model, and/or the combined model.

7. The image processing system according to claim l, wherein the X-ray projections originate from a circular and/or helical trajectory of an X-ray source around the body volume.

8. Examination apparatus, comprising:
an X-ray device for the generation of X-ray projections of the body volume from different directions, wherein projections can be based on at least two spectrally different samplings of X-rays;
an image processing system according to claims 1.

9. The examination apparatus according to claim 8, wherein the X-ray device comprises a cone-beam CT system, particularly a circular and/or helical cone-beam CT system.

10. The examination apparatus according to claim 8, wherein the X-ray device is adapted to generate X-radiation of at least two different spectra.

11. The examination apparatus according to claim 8, wherein the X-ray device is adapted to measure transmitted X-radiation with at least two different spectral weighting functions.

12. A method for the generation of a 3D model of a body volume from X-ray projections, comprising the following steps:
a) generating differently oriented X-ray projections of the body volume wherein at least two projections are based on spectrally different samplings of X-rays;
b) reconstructing a first 3D model and a second 3D model of the body volume from said projections, wherein projections based on spectrally different samplings of X-rays contribute with different weights to said 3D models;
c) combining the first and second 3D model to a combined 3D model of the body volume.

13. The method according to claim 12, wherein the first 3D model and the second 3D model of the body volume are reconstructed with different algorithms which are specifically adapted to the weighted projections and to associated artifacts.

14. The method according to claim 12, wherein the first and/or the second model is post-processed for image enhancement before step c).

15. The method according to claim 12, wherein the first 3D model and/or the second 3D model of the body volume are combined such that a desired contrast is enhanced or reduced.

16. The method according to claim 12, wherein the X-ray projections are generated with at least two different spectra of the illuminating X-rays.

17. The method according to claim 12, wherein transmitted X-rays are measured with at least two different spectral weighting functions.

18. The method according to claim 12, wherein the X-ray projections originate from a circular or helical trajectory of the X-ray source around the body volume.

19. A record carrier on which a computer program for the generation of a 3D model of a body volume from X-ray projections is stored, said program being adapted to execute a method according to claim 12.
